(19) United States
(12) Patent Application Publication
(10) Pub. No.: US 2004/0051044 A1
(43) Pub. Date: Mar. 18, 2004

(54) Device for determining the nuclide content of a radioactive fluid

(76) Inventors: Bjorn Bjurman, Osthammar (SE); Bjorn Grapengiesser, Vasteras (SE); Lembit Sihver, Vasteras (SE)

Correspondence Address: Swidler Berlin Shereff Friedman, Suite 300, 3000 K Street, Washington, DC, 20007, US

(21) Appl. No.: 10/432,268

(22) PCT Filed: Nov. 13, 2001
(86) PCT No.: PCT/SE01/02508

(30) Foreign Application Priority Data
Nov. 22, 2000 (SE) 0004284-6

(51) Int. Cl. G01T 1/20

(52) U.S. Cl. 250/364

(57) ABSTRACT

The invention refers to a device for determining the nuclide content of a radioactive fluid. The device comprises a space (2) for receiving the fluid, a primary detector (6) for detection of gamma radiation emitted form the fluid in the space (2), and a processing member (10) for determining the nuclide content of the fluid based on the detected gamma radiation. The primary detector (6) includes a first detector part (8) having a front end directed towards the space and a second detector part (9) arranged adjacent to said front end between the first detector part (8) and the space (2).

### BACKGROUND OF THE INVENTION AND PRIOR ART

The present invention refers to a device for determining the nuclide content of a radioactive fluid, comprising a space for receiving the fluid, a primary detector for detection of gamma radiation emitted form the fluid in the space, and a processing member for determining the nuclide content of the fluid based on the detected gamma radiation.

The present invention will be described in connection with the detection and measurement of the various nuclides in fluids in nuclear power plants, and more specifically in off-gases and coolant water from light water reactors, such as Boiling Water Reactors, BWR, and Pressure Water Reactors, PWR.

Fuel failures in BWR and PWR nuclear power plants can create severe problems ranging from worker hazards to unplanned shutdowns of the reactor. Prompt, detailed and accurate fuel failure detection is therefore very important for the operation of the nuclear power plant.

It is known to detect fuel failures by measuring the quantity of nuclides in the off-gases and the coolant in nuclear power plant, see WO99/27541. Xe-133 in the off-gases in a BWR, and Np-239 in the coolant in a BWR and a PWR, are two key nuclides for the evaluation of the fuel integrity.

However, such detection can be difficult when there are high activity levels from short-lived isotopes in the measured medium, i.e. from N-16 (t_{1/2}=7.14 s), C-15 (t_{1/2}=2.50 s), O-19 (t_{1/2}=27.1 s) and N-13 (t_{1/2}=10.0 min). These isotopes cause a high background from Compton scattering of their primary photons and from the annihilation peak, from pair production (in the detector itself, the surrounding material and in the measured medium) and its Compton scattering, see FIG. 1. This is valid in both the off-gases and the coolant water in BWR and PWR, independent of if there is a fuel failure or not in the core of the reactor. Compton scattering can also occur in the detector itself, in the surrounding material and in the measured medium.

When suppressing signals from Compton scattering, the overall suppression factor S is normally calculated according to 1/(1−x), where x is the fraction of the scattered photons, which results in successful vetoes of the primary signal. Thus, if 50% of the scattered photons result in successful vetoes of the primary signal, S=2. There is also a strong angle dependence in the Compton scattering process, see FIGS. 2 and 3. A detector system with total Compton suppression is not optimal when measuring on-line in a BWR or PWR, since such a guard detector should get too many signals and therefore limit the range of measurable intensities of the detector system.

WO 98/47023 discloses a device for determining nuclide contents of radioactive inert gases. The known device comprises a measuring chamber, which contains the inert gases, and a detector, which detects gamma radiation from the radioactive inert gases. Calculating members calculates the content of the different nuclides based on the detected gamma radiation. The detector has the shape of a plate having a thickness within the interval of 3 to 20 mm.

### SUMMARY OF THE INVENTION

The object of the present invention is to provide an improved device for determining the nuclide content of a radioactive fluid. More specifically, it is aimed at a device for on-line measurements, which fulfils the requirements of suppressing the background radiation in an appropriate manner.

This object is obtained by the device initially defined, which is characterised in that the primary detector includes a first detector part having a front end directed towards the space and a second detector part arranged adjacent to said front end between the first detector part and the space.

By such a detector arrangement the efficiency in determining the low energetic gamma rays from, for instance, Xe and Kr in off-gases in a BWR, and Xe, Kr, I and Np in a the coolant in BWR and PWR on-line is significantly increased during operation of the nuclear power plant. The detector arrangement also enables a considerably larger number of measurements of interesting nuclide contents per unit of time than the known prior art devices. Furthermore, the accuracy of the measurements is improved since the arrangement according to the invention enables an efficient suppression of the background radiation.

According to an embodiment of the present invention, the second detector part has a plate-like shape. Thereby the second detector part may be significantly thinner than the first detector part. Determination of the interesting low energetic gamma radiation is possible since the first, relatively thick detector part will only detect high energetic gamma radiation whereas the second relatively thin detector part will detect gamma radiation with all energies, however with a significant higher efficiency for low energies (about 50-500 keV). The processing member is preferably arranged not to register photons measured by both the detector parts, for instance signals from the second detector part will not be registered by the processing member when they are in coincidence with signals from the first detector part, by means of a so called anticoincidence gating technique.

According to a further embodiment of the present invention, the second detector part includes a HPGe-detector. In particular, the second detector part is a planar HPGe-detector.

According to a further embodiment of the present invention, the first detector part and the second detector part are formed by a common crystal, which is monolithically segmented into said two parts. Preferably, the external and internal electrical contacts are obtained by lithium diffusion. According to another embodiment of the present invention, the first detector part and the second detector part are formed by two separate crystals, which are arranged adjacent to each other. The choice of a common crystal detector or two separate detector parts is to be made depending on the particular circumstances, such as optimizing the resolution and throughput.

According to a further embodiment of the present invention, the device has a centre axis extending through the first detector part, the second detector part and the space. Preferably, the radial extension of the second detector part with respect to the centre axis is less than the radial extension of the first detector part.

According to a further embodiment of the present invention, the device includes a secondary detector having a front end directed towards the space and the primary detector. By such an additional detector also the radiation in the backward direction opposite to the forward direction measured by the primary detector may be considered in the determination of the content of specific nuclides. The secondary detector may be included in the anti-coincidence gating processing. Preferably, the centre axis extends through secondary detector. The secondary detector includes at least one of a BGO-detector and a NaI(Tl)-detector.

According to a further embodiment of the present invention, the first detector part includes at least one of a HPGe-detector, a BGO-detector and a NaI(Tl)-detector.

According to a further embodiment of the present invention, the space is defined by an enclosure. Moreover, the device may include an inlet channel for a substantially continuous supply of the fluid to the space and an outlet channel for a substantially continuous discharge of the fluid from the space.

According to a further embodiment of the present invention, the fluid is a gas and/or a liquid. In an advantageous application of the invention the device may be used to determine the nuclide content in the off-gases from a nuclear power plant and/or in the coolant of the nuclear power plant.

According to a further embodiment of the present invention, the first detector part is arranged to detect only gamma radiation of a relatively high energy, whereas the second detector part will detect gamma radiation of all energies, with a significantly higher efficiency for low energies. The processing member is thereby arranged to determine the quantity of said relatively low energy gamma radiation by means of anti-coincidence gating of signals from the first detector part and the second detector part.

According to a still further embodiment of the present invention, a secondary detector is arranged to detect only gamma radiation of a relatively high energy and from annihilation. The processing member is thereby arranged to determine the quantity of said relatively low energy gamma radiation by means of anti-coincidence gating of signals from the first detector part, the second detector part and the secondary detector.

### BRIEF DESCRIPTION OF THE DRAWINGS

The present invention is now to be explained more closely by means of a description of embodiments of the invention and also with reference to the drawings attached hereto.

FIG. 1 is a diagram showing the linear attenuation coefficient of germanium.

FIG. 2 is a plot of the photon energy as a function of the scattering angle.

FIG. 3 is a plot of the probability of scatter vs. angle (0 to 180°) for photons of various energies.

FIG. 4 is a diagram showing the energy distribution of electrons from Compton scattering for primary photons of 511, 1200 and 2760 keV, i.e. the relative background contribution from the annihilation process.

FIG. 5 is a diagram showing the scattering angles vs. Compton continuum. This figure illustrates that in order to suppress the low energy Compton continuum (e.g. from electrons with low energtic photons scattered with small angles has to be suppressed.

FIG. 6 discloses schematically a device according to an embodiment of the present invention.

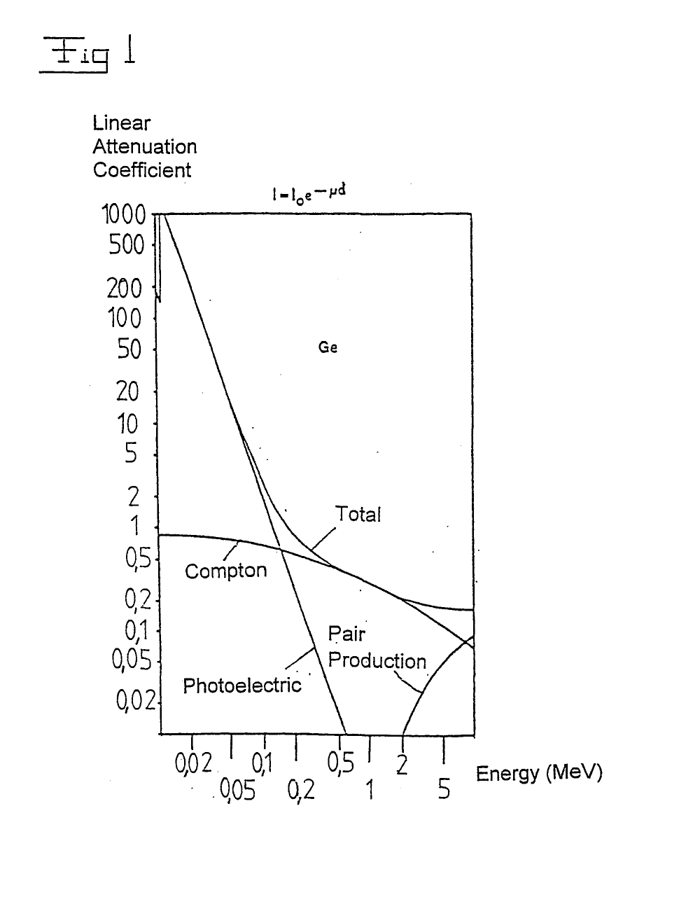

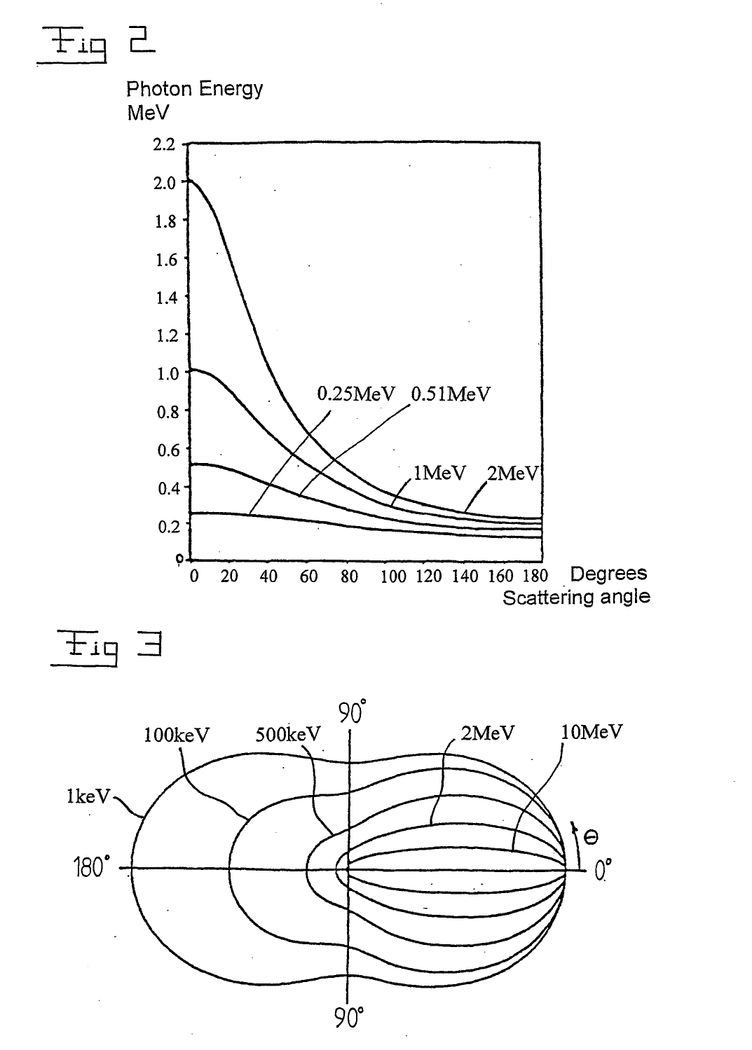

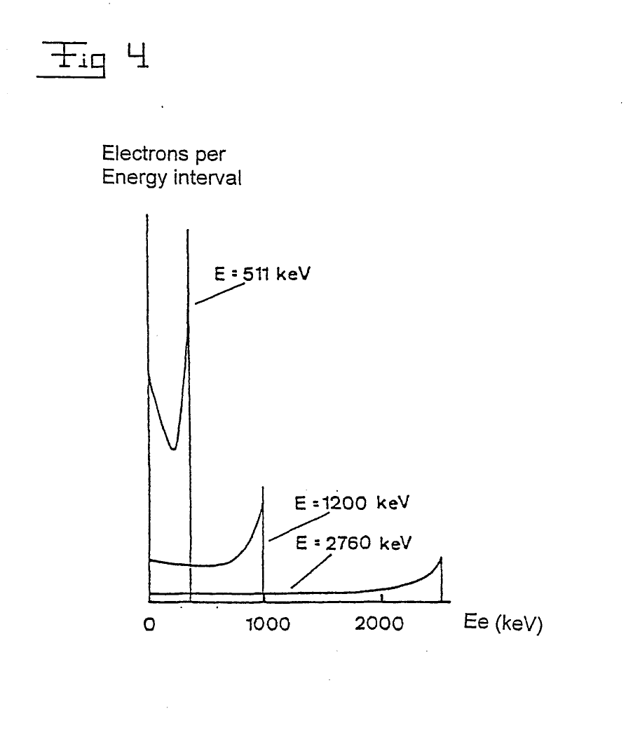

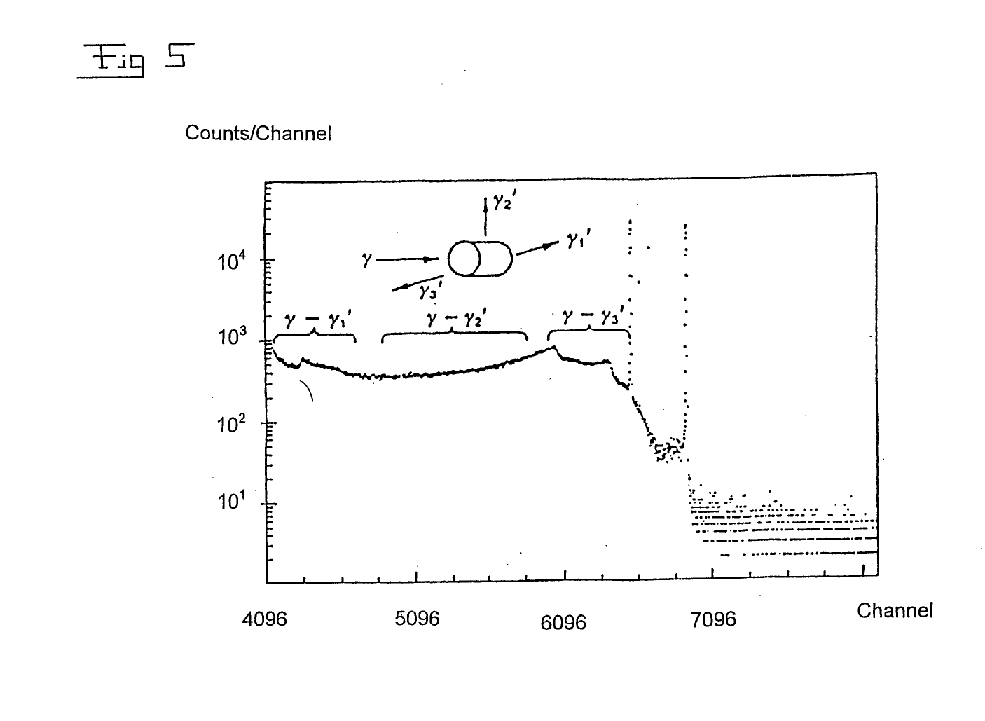

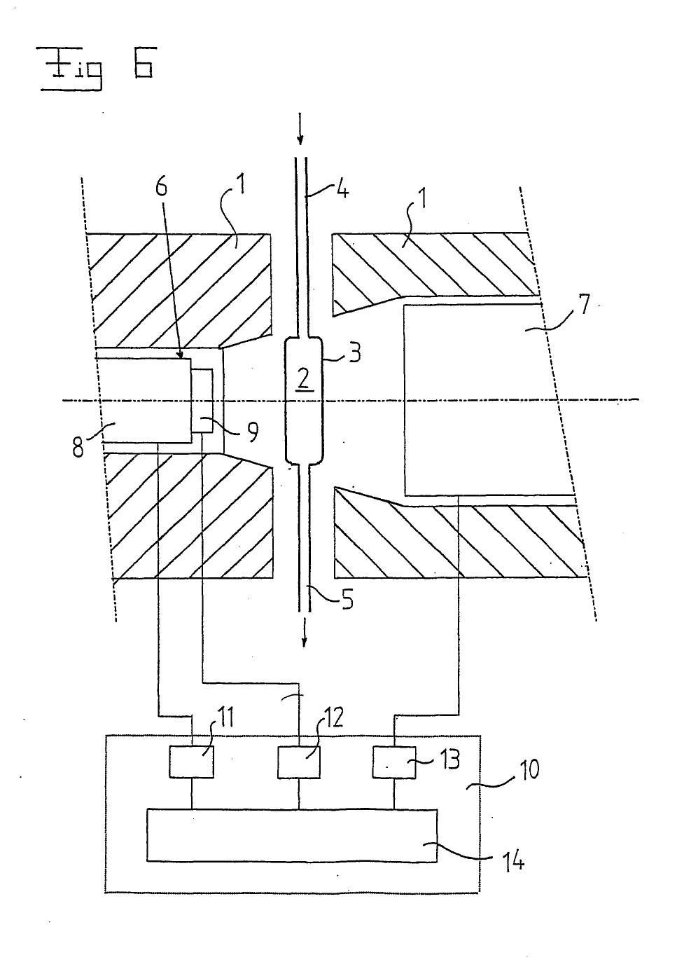

### DETAILED DESCRIPTION OF EMBODIMENTS OF THE PRESENT INVENTION

FIG. 6 discloses a device for determining, by detection and calculation, the nuclide contents of a radioactive fluid. The fluid may be a gas, for instant the off-gases which are produced by a nuclear reactor of a nuclear power plant during operation. The fluid may also be the coolant medium, substantially water, flowing through the nuclear reactor of a nuclear power plant. The invention is applicable to nuclear power plants of different types, especially light water reactors including boiling water reactors and pressure water reactors.

The device includes a housing 1 enclosing the active component of the device. The housing 1 forms a collimator and is preferably made of a material preventing penetration of radioactive radiation, such as lead. In the housing 1 a space 2 is provided for receiving the fluid. The space 2 is defined by an enclosure 3. The space 2 thus encloses a volume of the fluid, the nuclide content of which is to be determined by the device. The device includes an inlet channel 4 for the supply of the fluid to the space 2 and an outlet channel 5 for the discharge of the fluid from the space 2. The inlet channel 4, the space 2 and the outlet channel 5 are arranged to permit a substantially continuous flow of the fluid there through. The device may be provided in a nuclear reactor in such manner that a part of the off-gasses or the coolant is substantially continuously conveyed through the space 2. By such an arrangement a substantially on-line determination is possible.

Furthermore, the device includes a primary detector 6 and a secondary detector 7. The primary detector 6 includes a first detector part 8 and a second detector part 9. The device has a centre axis x extending through the centre of the space 2, the first detector part 8, the second detector part part 9 and the secondary detector 7. The detectors are arranged in such a way that the first detector part 8 has a front end directed towards the space 2, and the second detector part 9 is arranged adjacent to said front and between the first detector part 8 and the space 2. The secondary detector 7 also has a front and directed towards the space 2 and the primary detector 6 aligned with the centre axis x. Consequently, the secondary detector 7 is located on the other side of the space 2 opposite to the primary detector 6. The detectors 8, 9 and 7 are connected to a processing member 10 for the calculation of the nuclide contents to be determined. The processing member 10 may be designed in various ways and in the embodiment disclosed it includes for instance three counting members 11, 12, 13 one for each detector 8, 9 and 7. The counting members 11-13 are arranged to count the photons detected by the respective detector 8, 9 and 7. The counting members 11-13 are connected to an analysing unit 14 of the processing member 10 for analysing the results from the counting members 11-13 and the detectors 8, 9 and 7.

The first detector part 8 may include one of a HPGe-detector, a BGO-detector and a NaI(Tl)-detector. The secondary detector 7 may include one of a BGO-detector and a NaI(Tl)-detector. The second detector part 9 preferably includes a HPGe-detector. As appears from FIG. 6 the second detector part 9 is substantially thinner than the first detector part 8 seen along the centre axis x. Moreover, the second detector part 9 might have a smaller radial extension with regard to the centre axis x than the first detector part 8. Consequently, the second detector part 9 has a plate-like, planar shape.

According to one embodiment of the invention the first detector part 8 and the second detector part 9 may be formed by a common crystal, which is monolithically segmented into said two detector parts 8, 9. Such an arrangement may be obtained by known technique, wherein the external and internal electrical contacts usually are obtained by lithium diffusion. According to another embodiment, the first detector part 8 and the second detector part 9 are formed by separate crystals. The two separate crystals are arranged adjacent to each other. A small gap may be provided between the two separate crystals.

The first detector part 8 is arranged to detect only photons of a relatively high energy whereas the second detector part 9 is arranged to detect gamma radiation of all energies, however with a significantly higher efficiency for low energies (about 50-500 keV). The secondary detector 7 is arranged to detect only photons of high energy and annihilation radiation. Thus the secondary detector 7 and the first detector part 8 will function as guard detectors. The analysing unit 14 of the processing member 10 is arranged to determine the quantity of said relatively low energy photons, for instance from Xe-133 and Np-239, by means of anti-coincidence gating of the signals from the detectors 7, 8 and 9. In other words, the measurement result is based on anti-coincidence gating of the detector signals from the planar second detector part 9 with the signals from the first detector part 8 in the forward direction and the secondary detector 7 in the backward direction. Photons, which are measured in detector 9 in coincidence with 8 and/or 7, will not be registered by the device. The signals from the planar second detector part 9 will only be registered when they are not in coincidence with the signals from the guard detectors 8 and 7.

The arrangement according to the invention permits the suppression of the low energy Compton continuum without loss of proper signals. This is efficiently obtained since photons which will be Compton scattered with small angles in the planar second detection part 9 will also pass through the thicker first detector part 8 in the forward direction and the secondary detector 9 in the backward direction.

It is to be noted that the secondary detector 7 is not necessary according to the inventive concept. However, the provision of the secondary detector 7 may additionally improve the measurement results.

The present invention is not limited to the embodiments disclosed but may be varied and modified within the scope of the following claims.

1. A device for determining the nuclide content of a radioactive fluid, comprising a space (2) for receiving the fluid, a primary detector for detection of gamma radiation emitted form the fluid in the space (2), and a processing member for determining the nuclide content of the fluid based on the detected gamma radiation, characterised in that the primary detector (6) includes a first detector part (8) having a front end directed towards the space (2) and a second detector part (9) arranged adjacent to said front end between the first detector part (8) and the space (2).

2. A device according to claim 1, characterised in that the second detector part (9) has a plate-like shape.

3. A device according to any one of claims 1 and 2, characterised in that the second detector part (9) includes a HPGe-detector.

4. A device according to claims 2 and 3, characterised in that the second detector part (9) is a planar HPGe-detector.

5. A device according to any one of the preceding claims, characterised in that the first detector part (8) and the second detector part (9) are formed by a common crystal, which is monolithically segmented into said two parts.

6. A device according to any one of claims 1 to 4, characterised in that the first detector part (8) and the second detector part (9) are formed by respective crystals, which are arranged adjacent to each other.

7. A device according to any one of the preceding claims, characterised in that the device has a centre axis (x) extending through the first detector part (8), the second detector part (9) and the space (2).

8. A device according to claim 7, characterised in that the radial extension of the second detector part (9) with respect to the centre axis (x) is less than the radial extension of the first detector part (8).

9. A device according to any one of the preceding claims, characterised in that the first detector part (8) and the second detector part (9) are connected to the processing member (10).

10. A device according to any one of the preceding claims, characterised in that the device includes a secondary detector (7) having a front end directed towards the space and the primary detector (6).

11. A device according to claims 7 and 9, characterised in that the centre axis (x) extends through secondary detector (7).

12. A device according to any one of claims 10 and 11, characterised in that the secondary detector (7) includes at least one of a BGO-detector and a NaI(Tl)-detector.

13. A device according to any one of claims 10 to 12, characterised in that the secondary detector (9) is connected to the processing member (10).

14. A device according to any one of the preceding claims, characterised in that the first detector part(8) includes at least one of a HPGe-detector and a NaI(Tl)-detector.

15. A device according to any one of the preceding claims, characterised in that the space (2) is defined by an enclosure (3).

16. A device according to claim 15, characterised in that the device includes an inlet channel (4) for a substantially continuous supply of the fluid to the space (2) and an outlet channel (5) for a substantially continuous discharge of the fluid from the space (2).

17. A device according to any one of the preceding claims, characterised in that the fluid is a gas and/or a liquid.

18. A device according to any one of the preceding claims, characterised in that the first detector part (8) is arranged to detect only gamma radiation of a relatively high energy, and that second detector part (9) is arranged to detect gamma radiation of all energies, with a significantly higher efficiency for low energies.

19. A device according to claims 9 and 18, characterised in that the processing member (10) is arranged to determine the quantity of said relatively low energy gamma radiation by means of anti-coincidence gating of signals from the first detector part (8) and the second detector part (9).

20. A device according to claims 10 and 18, characterised in that the secondary detector (7) is arranged to detect only gamma radiation of a relatively high energy and from annihilation radiation.

21. A device according to claims 19 and 20, characterised in that the processing member (10) is arranged to determine the quantity of said relatively low energy gamma radiation by means of anti-coincidence gating of signals from the first detector part(8), the second detector part (9) and the secondary detector (7).
